(19) United States
(12) Patent Application Publication
(10) Pub. No.: US 2017/0063240 A1
(43) Pub. Date: Mar. 2, 2017

(54) DC-DC FLYBACK CONVERTER WITH PRIMARY SIDE AUXILIARY VOLTAGE OUTPUT

(71) Applicants: Nitin Kumar, Munich (DE); Markus Ziegler, Munich (DE); Andrew Johnsen, Danvers, MA (US)

(72) Inventors: Nitin Kumar, Munich (DE); Markus Ziegler, Munich (DE); Andrew Johnsen, Danvers, MA (US)

(73) Assignee: OSRAM SYLVANIA Inc., Danvers, MA (US)

(21) Appl. No.: 14/833,467

(22) Filed: Aug. 24, 2015

(51) Int. Cl. H02M 3/335

(52) U.S. Cl. CPC H02M 3/33507

(57) ABSTRACT

A DC-DC flyback converter includes a transformer and a switching component connected between the transformer and a ground. The switching component controls current flow through the primary winding of the transformer. A snubber circuit is connected between ground and the connection between the transformer and the switching component. The snubber circuit reduces transient voltage spikes across the switching component. A capacitive component of the snubber circuit provides stability for a primary side auxiliary output voltage while maintaining power factor and THD performance.

### TECHNICAL FIELD

The present invention relates to electronics, and more specifically, to flyback converters.

### BACKGROUND

Conventional incandescent lighting devices are being replaced by more energy efficient alternatives, such as lighting devices including one or more solid state light sources, such as but not limited to light emitting diodes. Unlike conventional incandescent lighting devices, solid state light source-based lighting devices do not directly utilize typical AC line voltages. Ballasts and inverters are used to provide power that is directly usable by the lighting devices from such mainline AC power. However, it can be difficult to implement such circuitry within packaging that enables the lighting device to be used in existing lighting fixtures. Further, it is sometimes necessary to supply auxiliary circuits such as fans and sensors so multiple output voltages may be required.

### SUMMARY

Basic components of a DC-DC voltage converter typically include an inductive component and a switching component that controls current flow through the inductive component. When the switch is closed, current flows through the inductive component. In particular, the current through the inductive component increases over time and energy is stored. When the switch is opened, the current stops flowing through the inductive component. The abrupt cessation of current flowing through the inductive component prompts the inductive component to generate an electromagnetic force by releasing the stored energy. This results in increased output voltage across the inductive component relative to the input voltage. However, the increased output voltage is only generated for a relatively short duration of time as the stored energy is released. Cycling the switch in order to repeatedly energize and de-energize the inductive component can be performed to generate an output voltage which is greater than the input voltage. A variety of different types of DC-DC voltage converters are known, not all of which are necessarily well suited for implementation with lighting devices.

In an embodiment, there is provided an apparatus. The apparatus includes: an inductive component connected to a direct current input voltage; a switching component connected between the inductive component and ground; and a snubber circuit connected between the inductive component and ground.

In a related embodiment, the snubber circuit may include a capacitive component. In a further related embodiment, the apparatus may further include an auxiliary voltage output between the inductive component and the capacitive component. In a further related embodiment, the snubber circuit may further include a diode and a resistor.

In another related embodiment, the inductive component may include a transformer, and the switching component and the snubber circuit may be connected to a primary winding of the transformer. In a further related embodiment, the switching component may include a FET (field effect transistor).

In another embodiment, there is provided a method of converting a first voltage to a second voltage, where the second voltage is greater than the first voltage. The method includes: storing energy in an inductive component in response to the first voltage; releasing energy stored in the inductive component by interrupting current flow through the inductive component with a switching component connected between the inductive component and ground, thereby providing the second voltage; and reducing transient voltage magnitude across the switching component with a snubber circuit connected between the inductive component and ground.

In a related embodiment, reducing may include: reducing transient voltage magnitude across the switching component with a snubber circuit connected between the inductive component and ground, wherein the snubber circuit may include a capacitive component; and the method may further include providing an auxiliary voltage output between the inductive component and the capacitive component.

In another embodiment, there is provided a DC-DC flyback converter. The DC-DC flyback converter includes: a transformer comprising a primary winding and a secondary winding; a switching component connected between the primary winding of the transformer and ground; and a snubber circuit connected between the primary winding of the transformer and ground.

In a related embodiment, the switching component may include a FET (filed effect transistor) having a gate, a source, and a drain, and the snubber circuit may be connected to the source of the FET. In a further related embodiment, the snubber circuit may include a capacitor. In a further related embodiment, the DC-DC flyback converter may include an auxiliary voltage output between the primary winding of the transformer and the capacitor of the snubber circuit. In a further related embodiment, the snubber circuit may further include a diode, and the auxiliary voltage output may be between the diode and the capacitor of the snubber circuit. In a further related embodiment, the snubber circuit may further include a resistor in parallel with the capacitor.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a schematic diagram of a basic DC-DC flyback converter.

FIG. 2 is a schematic diagram of a DC-DC flyback converter with a snubber to rail circuit and a voltage supply capacitor for keeping the rectified rail stable and to supply a stable auxiliary primary side voltage output.

FIG. 3 is a schematic diagram of a DC-DC flyback converter with a snubber to ground according to embodiments disclosed herein.

FIG. 4A illustrates a drain-source voltage V_{DS} across the switch of the basic flyback converter of FIG. 1.

FIG. 4B illustrates a drain-source voltage V_{DS} across the switch of the flyback converter with snubber to ground across the switch of FIG. 3.

FIG. 5A illustrates conducted EMI at Vᵢₙ of 120V for the basic flyback converter of FIG. 1.

FIG. 5B illustrates conducted EMI at Vᵢₙ of 120V for the flyback converter with snubber to ground of FIG. 3.

FIG. 6 illustrates a flowchart of a method of converting a first voltage to a second voltage, where the second voltage is greater than the first voltage according to embodiments disclosed herein.

### DETAILED DESCRIPTION

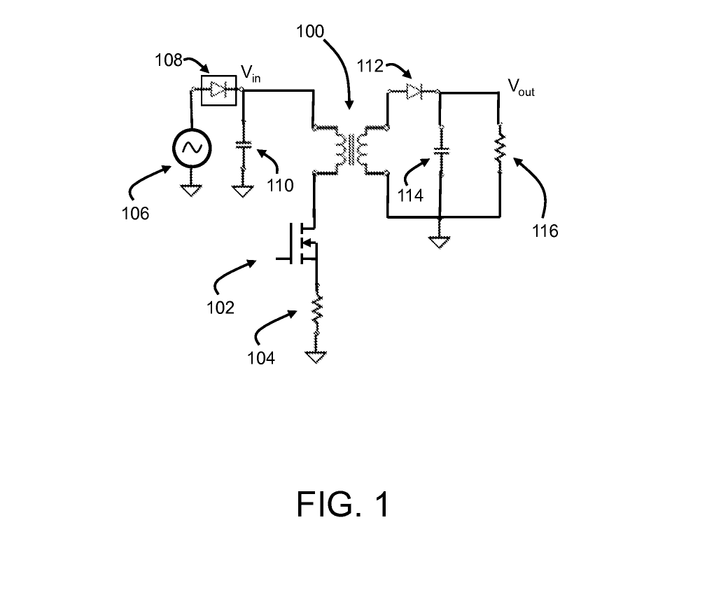

FIG. 1 is a schematic diagram of a basic DC-DC flyback converter. The basic DC-DC flyback converter includes a transformer 100 as an inductive component and a transistor such as a FET (field effect transistor) 102 as a switching component. A shunt resistor 104, to measure current, is connected between a drain of the FET 102 and ground. An input voltage Vᵢₙ is provided by an AC voltage source 106 and a rectifying circuit 108, such as but not limited to a full bridge rectifier. In some embodiments, a DC voltage source could be used to provide the input voltage Vᵢₙ, such as but not limited to a battery. However, the AC voltage source would be more typical for a lighting fixture powered via mainline AC power, such as found at a wall outlet or electrical junction box. A decoupling capacitor 110 is connected between the rectifying circuit 108 and a primary side winding of the transformer 100. On a secondary side winding of the transformer 100, a DC output voltage Vₒᵤₜ is provided by an RCD circuit including a diode 112, a buffering capacitor 114, and a resistor (or load) 116. The primary side winding of the transformer 100 has an inductance L1 and the secondary side winding of the transformer 100 has an inductance L2. Further, the secondary side winding has some multiple of the number of turns of the primary side winding.

The basic flyback converter operates in accordance with the principles described above. At the beginning of a cycle, the FET 102 is in an ON state, so the switch is closed and current flows through the primary side winding of the transformer 100. The flow of current through the primary side winding induces a negative voltage across the secondary side winding. The negative voltage reverse biases the diode 112 on the secondary side, thereby preventing current flow across the secondary winding. This continues for a predetermined amount of time during which energy is stored in the transformer 100. The state of the FET 102 is then switched to OFF, opening the switch. Opening the switch abruptly ceases current flow through the primary side winding, which induces a positive voltage across the secondary side winding. The induced positive voltage forward biases the diode 112, thereby allowing current to flow through the secondary winding and charging the buffer capacitor 114 as the transformer 100 releases stored energy. When the energy stored in the transformer 100 has been exhausted, the current through the secondary winding drops to zero. The state of the switch 102 is then changed to ON and the cycle is repeated. A control circuit connected to a gate of the FET 102 prompts cycling at a predetermined frequency in order to provide the DC output voltage Vₒᵤₜ from the input voltage Vᵢₙ.

Flyback converters are well suited for providing multiple output voltages in compact form factor implementations because relatively little additional circuitry is required for each additional output. However, large transient voltage spikes may be presented at the drain of the switch and at the secondary side diode. The voltage spikes are a function of the leakage inductance in the transformer. The primary leakage inductance does not have a discharge path for the energy stored when the switch is closed and does not contribute to the energy transfer from the primary winding to the secondary winding. This leads to a voltage spike each time the switch is opened. The voltage spikes are problematic because they can generate EMI (electromagnetic interference), which may cause problems for other circuitry. The large transient voltage spikes may also create problems for the power supply, which must respond to the abrupt changes of current flow and voltage.

Another problem associated with the basic flyback converter is stress on the switching component. As the flyback converter cycles, the switch is alternately subjected to the stress of high current when closed and the stress of high blocking voltage when open. Switches with high breakdown voltage can be used. However, switches with high breakdown voltage are typically characterized by relatively higher RON (ON resistance) than switches with low breakdown voltage at the same component cost. Use of switches with high breakdown voltage can therefore reduce the efficiency of the voltage converter, which is undesirable.

Another problem with the basic flyback converter is that it does not provide a stable primary side auxiliary voltage output without compromise on power factor and THD (total harmonic distortion) if a bulk storage capacitor is used to maintain a stable rectified rail voltage. A primary side auxiliary voltage output may be required in some implementations. For example, a primary side auxiliary voltage output that remains stable for approximately 300 ms after switch turn off is a DALI standards requirement.

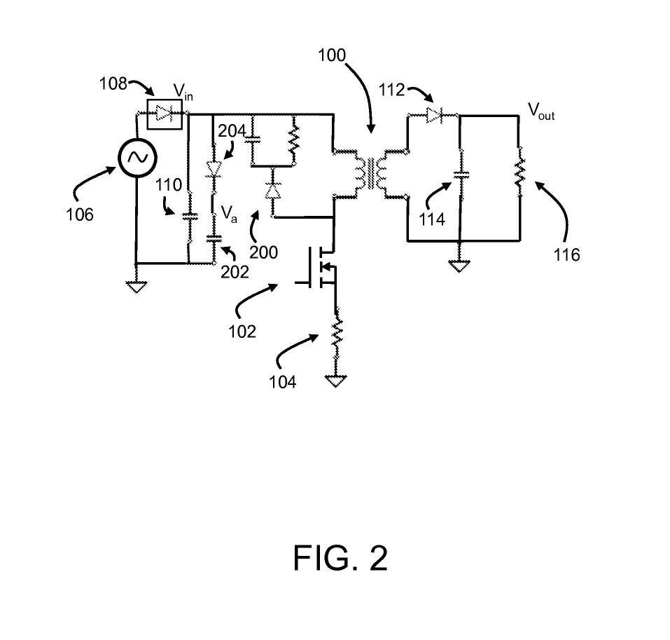

FIG. 2 illustrates a modified flyback converter with circuitry to provide a stable primary side auxiliary voltage and help overcome some of the problems of the basic flyback converter described above. The modified flyback converter includes a snubber circuit 200 to rail, a power supply capacitor 202, and a decoupling diode 204. An auxiliary voltage output V_{A} on the primary side of the transformer 100 is provided across the power supply capacitor 202. The power supply capacitor 202 has a much larger capacitance than the decoupling capacitor 110. The snubber circuit 200 is a dissipative circuit that includes a diode connected to a resistor and capacitor which are in parallel. The snubber circuit 200 mitigates generation of EMI by controlling the rate of change of current flow through the primary winding of the transformer 100, thereby limiting the rate of rise in voltage (dV/dt) across the primary side winding and the FET 102. Together, the snubber circuit 200 and the power supply capacitor 202 control the effects of the leakage inductance, improve the reliability of the power supply, and provide an auxiliary output voltage V_{A} on the primary side. However, the dissipative nature of the snubber circuit 200 to rail reduces efficiency. Further, the design results in a low power factor and high THD.

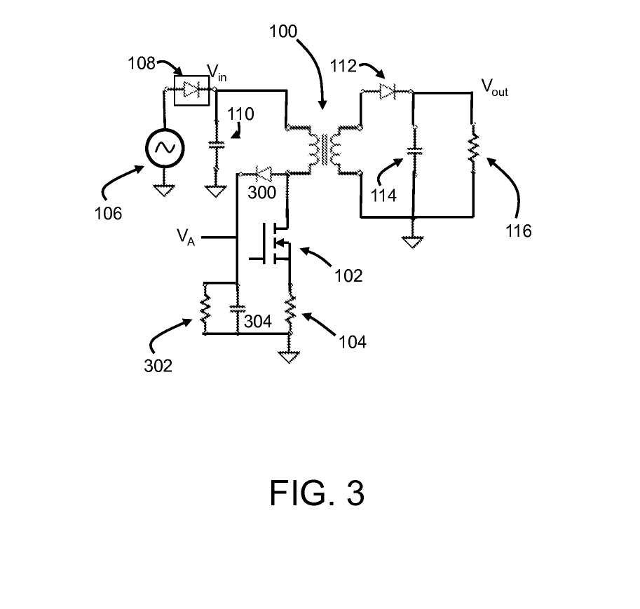

FIG. 3 illustrates a flyback converter that provides an extended primary side auxiliary output voltage V_{A} while mitigating EMI and avoiding some of the drawbacks of the previously described designs. The flyback converter of FIG. 3 includes a snubber circuit to ground from the switch input side, e.g., a source of the FET 102, and the primary side winding of the transformer 100. The snubber circuit includes a diode 300, a resistor 302, and a capacitor 304. However, a wide variety of snubber circuits could be used, including but not limited to various combinations of one or more of a resistor, a capacitor, and a diode. In the illustrated example, the diode 300 is connected to the source of the FET 102 and to the primary side winding of the transformer 100. The resistor 302 and the capacitor 304 form a parallel RC circuit, which is in series with the diode 300, and is connected between the diode 300 and ground. The snubber circuit mitigates generation of EMI by controlling the rate of change of current flow through the primary side winding of the transformer 100, and across the FET 102, thereby limiting the rate of rise in voltage (dV/dt) across the primary side winding of the transformer 100 and the FET 102. Moreover, the capacitor 304 of the snubber circuit provides stability for the primary side auxiliary output voltage V_{A}. For example and without limitation, the primary side auxiliary output voltage V_{A} in some embodiments remains stable for some period of time, e.g., approximately 300 ms, after the FET 102 turns OFF. In comparison with the design shown in FIG. 2, snubbing is still provided to reduce transient voltage spikes while reducing EMI and providing time-extended primary side auxiliary output voltage V_{A}, but this is accomplished with fewer components and without causing low power factor and high THD.

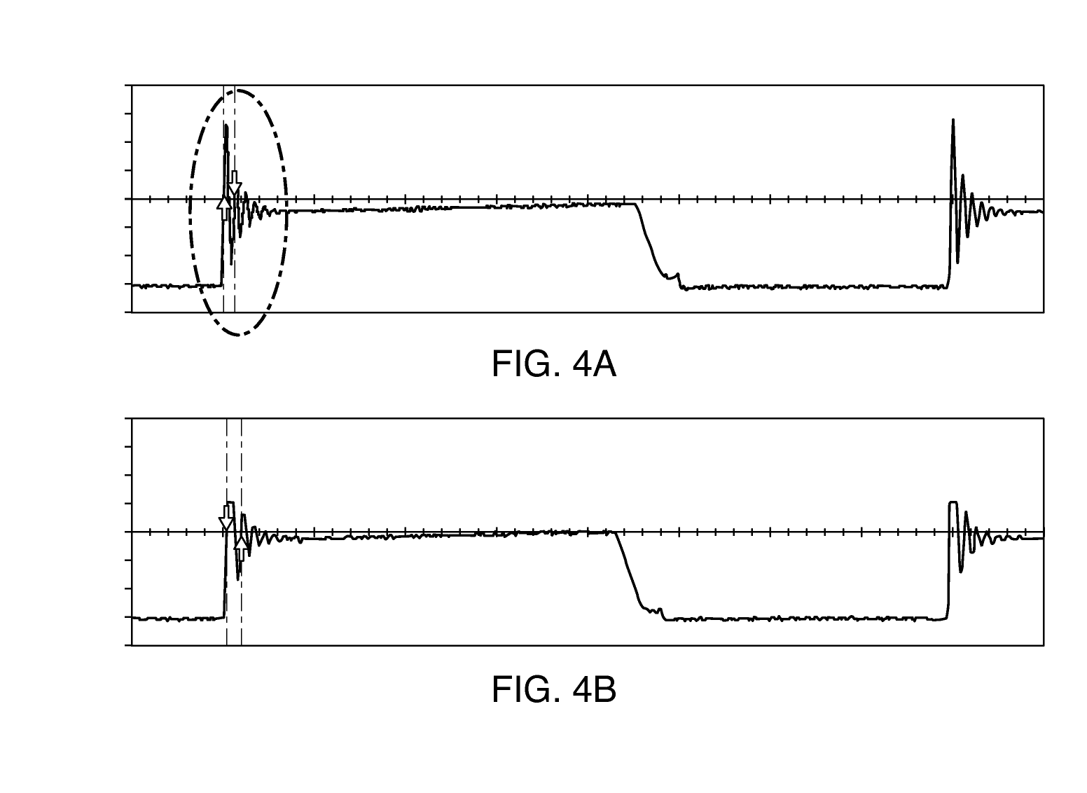

FIGS. 4A and 4B illustrate the drain-source voltage V_{DS} across the FET 102 for the basic flyback converter shown in FIG. 1 and the flyback converter with snubber circuit to ground across the switch shown in FIG. 3, respectively. It can be seen that the magnitude of the problematic voltage transients (shown in the y-axis) associated with the FET turn OFF is reduced in FIG. 4B, which corresponds to the circuit of FIG. 3, in comparison with FIG. 4A, which corresponds to the circuit of FIG. 1.

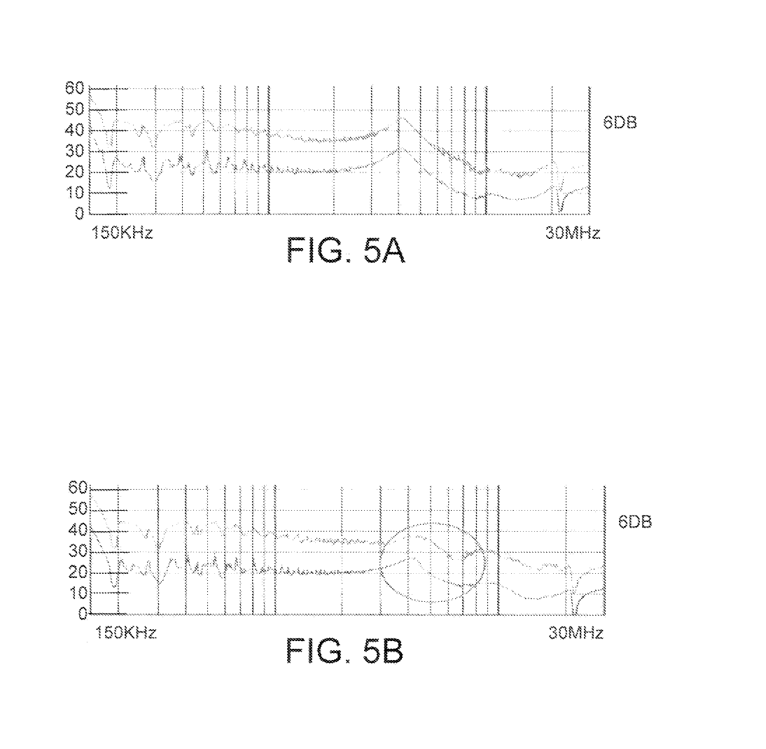

FIGS. 5A and 5B illustrate conducted EMI at Vᵢₙ of 120V for the basic flyback converter of FIG. 1 and the flyback converter with snubber circuit to ground of FIG. 3, respectively. It can be seen that the magnitude of the problematic EMI is reduced in FIG. 5B, which corresponds to the circuit of FIG. 3, in comparison with FIG. 5A, which corresponds to the circuit of FIG. 1.

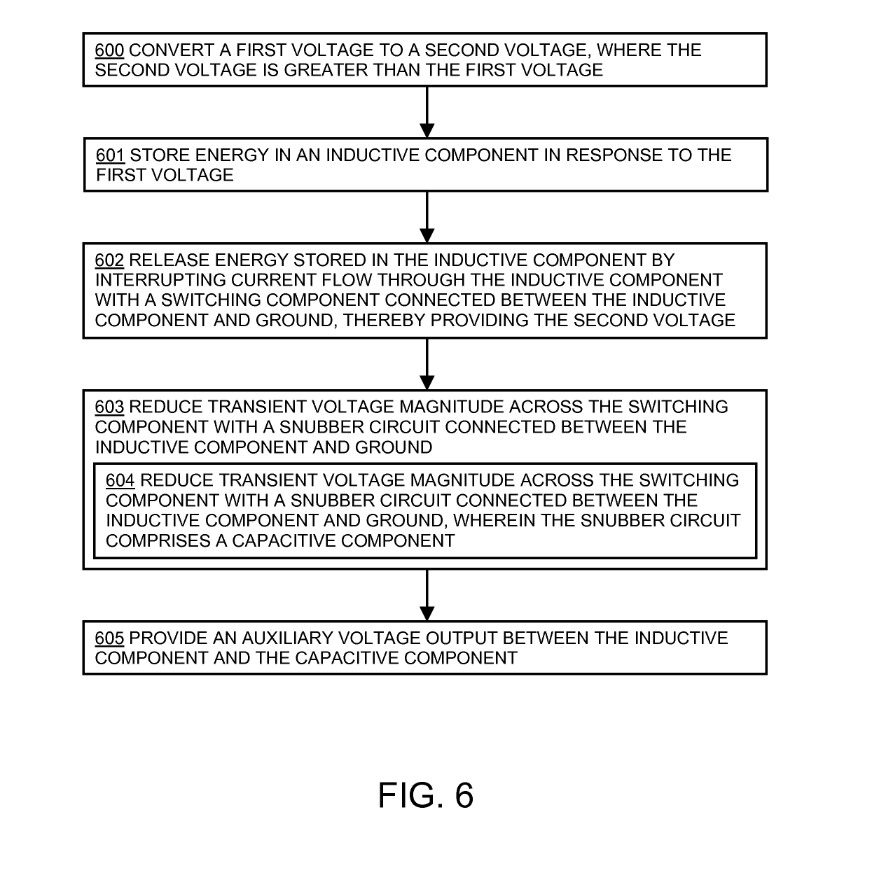

A flowchart of a method 600 is depicted in FIG. 6. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks. Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables, are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Further, while FIG. 6 illustrates various operations, it is to be understood that not all of the operations depicted in FIG. 6 are necessary for other embodiments to function. Indeed, it is fully contemplated herein that in other embodiments of the present disclosure, the operations depicted in FIG. 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

In the method 600 of FIG. 6, energy is stored in an inductive component in response to the first voltage, step 601. Energy stored in the inductive component is released by interrupting current flow through the inductive component with a switching component connected between the inductive component and ground, thereby providing the second voltage, step 602. Transient voltage magnitude is reduced across the switching component with a snubber circuit connected between the inductive component and ground, step 603. In some embodiments, transient voltage magnitude is reduced across the switching component with a snubber circuit connected between the inductive component and ground, wherein the snubber circuit comprises a capacitive component, step 604. In such embodiments, the method 600 may further include an auxiliary voltage output provided between the inductive component and the capacitive component, step 605.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. An apparatus comprising:
an inductive component connected to a direct current input voltage;
a switching component connected between the inductive component and ground; and
a snubber circuit connected between the inductive component and ground.

2. The apparatus of claim 1, wherein the snubber circuit comprises a capacitive component.

3. The apparatus of claim 2, further comprising an auxiliary voltage output between the inductive component and the capacitive component.

4. The apparatus of claim 3, wherein the snubber circuit further comprises a diode and a resistor.

5. The apparatus of claim 1, wherein the inductive component comprises a transformer, and wherein the switching component and the snubber circuit are connected to a primary winding of the transformer.

6. The apparatus of claim 5, wherein the switching component comprises a FET (field effect transistor).

7. A method of converting a first voltage to a second voltage, where the second voltage is greater than the first voltage, comprising:
storing energy in an inductive component in response to the first voltage;
releasing energy stored in the inductive component by interrupting current flow through the inductive component with a switching component connected between the inductive component and ground, thereby providing the second voltage; and
reducing transient voltage magnitude across the switching component with a snubber circuit connected between the inductive component and ground.

8. The method of claim 7, wherein reducing comprises:
reducing transient voltage magnitude across the switching component with a snubber circuit connected between the inductive component and ground, wherein the snubber circuit comprises a capacitive component;
and wherein the method further comprises:
providing an auxiliary voltage output between the inductive component and the capacitive component.

9. A DC-DC flyback converter comprising:
a transformer comprising a primary winding and a secondary winding;
a switching component connected between the primary winding of the transformer and ground; and
a snubber circuit connected between the primary winding of the transformer and ground.

10. The DC-DC flyback converter of claim 9, wherein the switching component comprises a FET (filed effect transistor) having a gate, a source, and a drain, and wherein the snubber circuit is connected to the source of the FET.

11. The DC-DC flyback converter of claim 10, wherein the snubber circuit comprises a capacitor.

12. The DC-DC flyback converter of claim 11, comprising an auxiliary voltage output between the primary winding of the transformer and the capacitor of the snubber circuit.

13. The DC-DC flyback converter of claim 12, wherein the snubber circuit further comprises a diode, and wherein the auxiliary voltage output is between the diode and the capacitor of the snubber circuit.

14. The DC-DC flyback of claim 13, wherein the snubber circuit further comprises a resistor in parallel with the capacitor.
